(19) United States
(12) Patent Application Publication
(10) Pub. No.: US 2012/0258721 A1
(43) Pub. Date: Oct. 11, 2012

(54) METHOD AND APPARATUS FOR OPERATING COMPONENT CARRIERS IN A WIRELESS COMMUNICATION SYSTEM

(75) Inventors: Kibum Kwon, Ansan-si (KR); Myungcheul Jung, Seoul (KR); Sungjin Suh, Seoul (KR)

(73) Assignee: Pantech Co., Ltd., Seoul (KR)

(21) Appl. No.: 13/517,172

(22) PCT Filed: Dec. 21, 2010
(86) PCT No.: PCT/KR2010/009152

§ 371 Date: Jun. 19, 2012

(30) Foreign Application Priority Data
Dec. 24, 2009 (KR) 10-2009-0131027

(51) Int. Cl. H04W 72/04

(52) U.S. Cl. 455/450

(57) ABSTRACT

The present invention relates to a method and apparatus for operating component carriers in a wireless communication system. The method for operating component carriers according to one embodiment of the present invention comprises the following steps: determining whether or not to reconfigure component carriers of user equipment, and transmitting, to the user equipment, a reconfiguration message containing information on uplink component carriers to be allocated to a cell; allocating a resource in the cell as an uplink component carrier resource; and receiving, from the user equipment, a message containing the result of the allocation of the uplink component carriers via the allocated uplink component carriers.

### CROSS-REFERENCE TO RELATED APPLICATIONS

This application is the National Stage Entry of International Application PCT/KR2010/009152, filed on Dec. 21, 2010, and claims priority from and the benefit of Korean Patent Application No. 10-2009-0131027, filed on Dec. 24, 2009, both of which are incorporated herein by reference for all purposes as if fully set forth herein.

### BACKGROUND

1. Field

The present invention relates to a method and apparatus for operating component carriers (CCs), based on CC reconfiguration that adds or removes a predetermined CC from among a plurality of CCs, in a wireless communication system.

2. Discussion of the Background

In a wireless communication network environment that operates a plurality of component carriers (CCs), a CC reconfiguration process that selects a CC so as to allocate the CC to a user equipment (UE), and that removes the allocated CC, may be required. In other words, there is a desire for a CC reconfiguration scheme that is more compressive and flexible.

Also, the wireless communication network that operates a plurality of CCs may frequently set a CC. Accordingly, there is a desire for a scheme that is capable of providing immediate reconfiguration with respect to CCs and a mobility of the UE.

### SUMMARY

Therefore, an aspect of the present invention is to provide a method and apparatus for operating component carriers (CCs) in a wireless communication system.

Another aspect of the present invention is to provide a method and apparatus for reconfiguring a plurality of CCs in a wireless communication system.

Another aspect of the present invention is to provide a method and apparatus that performs CC reconfiguration by adding a CC in a wireless communication system.

Another aspect of the present invention is to provide a method and apparatus that performs CC reconfiguration by removing a CC in a wireless communication system.

Another aspect of the present invention is to provide a method and is apparatus that performs CC reconfiguration by changing a CC in a wireless communication system.

In accordance with an aspect of the present invention, there is provided a method for an e-Node B (eNB) to operate a component carrier (CC), the method including: determining whether to perform CC reconfiguration with respect to a user equipment (UE), and transmitting, to the UE through use of one of a first cell and a second cell, a radio resource control (RRC) connection reconfiguration message including information associated with an uplink (UL) CC that is to be allocated to the second cell; allocating a resource in the second cell as a UL CC resource; and receiving, from the UE through the UL CC allocated to the second cell, a CC reconfiguration complete message including a result of the allocation of the UL CC.

In accordance with another aspect of the present invention, there is provided a method for a UE to operate a CC, the method including: receiving, from an eNB through use of one of a first cell and a second cell, a RRC connection reconfiguration message including information associated with a UL CC to be allocated to the second cell; receiving allocation of a resource included in the second cell from the eNB, and allocating the allocated resource as a UL CC resource; and transmitting, to the eNB through the UL CC allocated to the second cell, a CC reconfiguration complete message including a result of the allocation of the UL CC.

In accordance with another aspect of the present invention, there is provided an apparatus for operating a CC, the apparatus including: a controller to determine whether to perform CC reconfiguration with respect to a UE, to generate an RRC connection reconfiguration message including information associated with a UL CC is that is to be allocated to a second cell, for the UE, and to allocate a resource in the second cell as a UL CC resource; a transmitting unit to transmit the RRC connection reconfiguration message through use of one of a first cell and the second cell; and a receiving unit to receive, from the UE through the UL CC allocated to the second cell, a CC reconfiguration complete message including a result of the allocation of the UL CC.

In accordance with another aspect of the present invention, there is provided an apparatus for operating a CC, the apparatus including: a receiving unit to receive, from an eNB through use of one of a first cell and a second cell, an RRC connection reconfiguration message including information associated with a UL CC to be allocated to the second cell; a controller to receive allocation of a resource included in the second cell from the eNB, and to allocate the allocated resource as a UL CC resource; and a transmitting unit to transmit, to the eNB through the UL CC allocated to the second cell, a CC reconfiguration complete message including a result of the allocation of the UL CC.

In accordance with another aspect of the present invention, there is provided a method for an eNB to operate a CC, the method including: determining whether to perform CC reconfiguration with respect to a UE, and transmitting, to the UE through use of a first cell, an RRC reconfiguration message including information associated with a downlink (DL) CC to be allocated to a second cell; allocating a resource included in the second cell as a DL CC resource; and receiving, from the UE through a UL CC allocated to the first cell or the second cell, a CC reconfiguration complete message including a result of the allocation of the DL CC.

In accordance with another aspect of the present invention, there is is provided a method for an eNB to operate a CC, the method including: determining whether to perform CC reconfiguration with respect to a UE, and transmitting, to the UE through use of a first cell or a second cell, an RRC reconfiguration message including information associated with a DL CC to be removed from the second cell; removing an allocated DL CC resource from the second cell; and receiving, from the UE through use of a UL CC allocated to the first cell or the second cell, a CC reconfiguration complete message including a result of the removal of the DL CC.

In accordance with another aspect of the present invention, there is provided a method for an eNB to operate a CC, the method including: determining whether to perform CC reconfiguration with respect to a UE, and transmitting, to the UE through use of a first cell or a second cell, an RRC connection reconfiguration message including information associated with a UL CC to be removed from the second cell; removing an allocated UL CC resource from the second cell; and receiving, from the UE through use of a UL CC allocated to the first cell, a CC reconfiguration complete message including a result of the removal of the UL CC.

In accordance with another aspect of the present invention, there is provided a method for a UE to operate a CC, the method including: receiving, from an eNB through use of a first cell, an RRC connection reconfiguration message including information associated with a DL CC to be allocated to a second cell; receiving allocation of a resource included in the second cell from the eNB, and allocating the allocated resource as a DL CC resource; and transmitting, to the eNB through use of a UL CC allocated to the first cell or the second cell, a UL CC reconfiguration complete message including a result of the allocation of the DL CC.

In accordance with another aspect of the present invention, there is provided a method for a UE to operate a CC, the method including: receiving, from the eNB through use of a first cell or a second cell, an RRC reconfiguration message including information associated with a DL CC to be removed from the second cell; removing the DL CC allocated from the eNB to a resource included in the second cell; and transmitting, to the eNB through use of a UL CC allocated to the first cell or the second cell, a CC reconfiguration complete message including a result of the removal of the DL CC.

In accordance with another aspect of the present invention, there is provided a method for a UE to operate a CC, the method including: receiving, from an eNB through use of a first cell or a second cell, an RRC connection reconfiguration message including information associated with a UL CC to be removed from the second cell; removing the UL CC allocated from the eNB to a resource included in the second cell; and transmitting, to the eNB through use of a UL CC allocated to the first cell, a CC reconfiguration complete message including a result of the removal of the UL CC.

In accordance with another aspect of the present invention, there is provided an apparatus for operating a CC, the apparatus including: a receiving unit to receive, from a user equipment (UE), a message including information associated with a CC; a controller to determine whether to perform CC reconfiguration with respect to a secondary cell, based on the information included in the message; a message generating unit to generate a radio resource control (RRC) connection reconfiguration message including information associated with a CC to be reconfigured in the UE; and a transmitting unit to transmit the generated message to the UE through use of a primary is cell or a secondary cell, and the controller performs controlling so that the receiving unit receives a CC reconfiguration complete message including a reconfiguration result of the reconfigured CC from the UE, and controls the transmitting unit and the receiving unit to perform transmission and reception of data with the UE, based on a configuration of the reconfigured CC.

In accordance with another aspect of the present invention, there is provided a UE, including: a message generating unit to generate a message including information associated with a component carrier (CC) to be reconfigured in a secondary cell; a transmitting unit to transmit the generated message to the eNB; a receiving unit to receive, from the eNB through a primary cell or the secondary cell, an RRC reconfiguration message including information associated with the CC to be reconfigured; and a controller to control the message generating unit, the transmitting unit, and the receiving unit, and the message generating unit generates a CC reconfiguration complete message including a reconfiguration result associated with the received reconfiguration message; and the controller performs controlling so that the transmitting unit transmits the CC reconfiguration complete message to the eNB, and controls the receiving unit and the transmitting unit to perform reception and transmission of data with the eNB based on a configuration of the reconfigured CC.

According to embodiments of the present invention, CC reconfiguration may be compressively and flexibly performed when adding or removal of a component carrier (CC) is performed and a backward compatible (BC) CC or a non-backward compatible (NBC) CC is operated between a user equipment (UE) and an e-Node B (eNB) in a wireless communication system that operates a plurality of CCs.

According to embodiments of the present invention, a CC appropriate for a UE is selected from among available CCs based on a predetermined rule or existing measurement values and the corresponding CC is added or activated, or a CC inappropriate for the UE is selected from among existing CCs set for the UE or activated CCs, and the corresponding CC may be removed or inactivated. Accordingly, reconfiguration of available CCs with respect to the UE may be effectively performed.

### BRIEF DESCRIPTION OF THE DRAWINGS

FIG. 1 is a diagram illustrating a process of reconfiguring a component carrier according to an embodiment of the present invention;

FIG. 2 is a diagram illustrating a process of additionally allocating a CC according to an embodiment of the present invention;

FIG. 3 is a diagram illustrating a process of additionally allocating a downlink (DL) non-backward compatible (NBC) CC according to an embodiment of the present invention;

FIG. 4 is a diagram illustrating a process of additionally allocating an uplink (UL) NBC CC according to an embodiment of the present invention;

FIG. 5 is a diagram illustrating processes for removing a CC of a user equipment (UE) according to an embodiment of the present invention;

FIG. 6 is a diagram illustrating processes for changing a location of a CC according to an embodiment of the present invention;

FIG. 7 is a diagram illustrating an example of operating CCs by newly allocating a CC according to an embodiment of the present invention;

FIG. 8 is a diagram illustrating another example of operating CCs by removing a CC according to an embodiment of the present invention;

FIG. 9 is a diagram illustrating another example of operating CCs by changing a CC according to an embodiment of the present invention;

FIG. 10 is a diagram illustrating a configuration of an e-Node B (eNB) that operates CCs by changing a CC according to an embodiment of the present invention; and

FIG. 11 is a diagram illustrating a configuration of a UE that operates CCs by changing a CC according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

Also, embodiments of the present invention will be described based on a wireless communication network, and operations in the wireless communication network may be performed in a process in which a system that manages the wireless communication network, for example, an e-Node (eNB), controls the network and transmits data, or may be performed in a UE that is connected to the corresponding is wireless network.

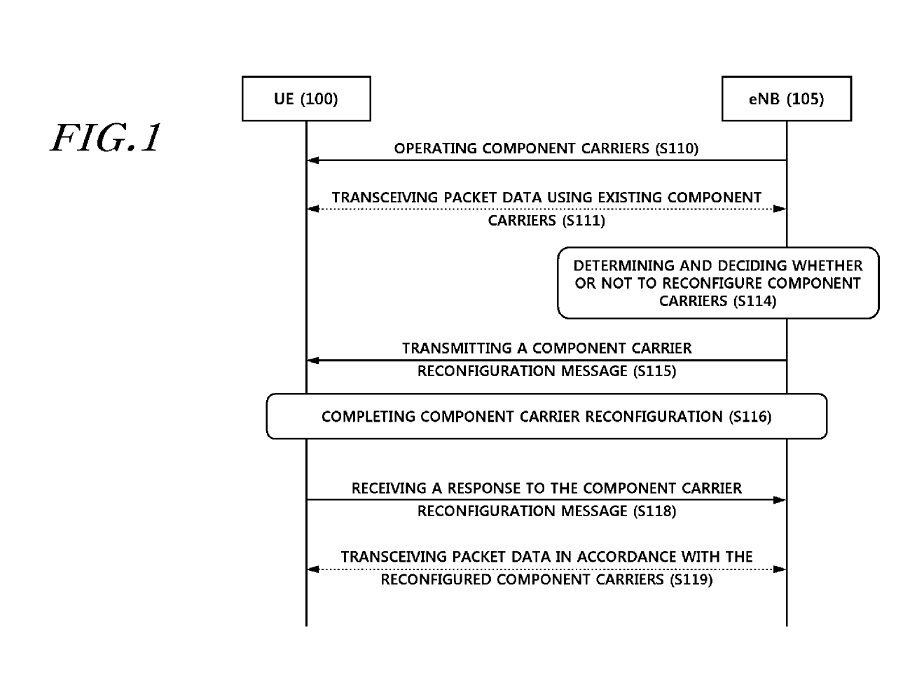

FIG. 1 illustrates a process of reconfiguring a component carrier (CC) according to an embodiment of the present invention.

FIG. 1 includes a process in which an e-Node B (eNB) 105 performs reconfiguration for operating CCs, such as addition, removal, changing, and the like, and a process in which a user equipment (UE) that uses at least one CC changes a CC for operating CCs, such as receiving allocation of a new CC, removal of a CC, a changing a band of a CC, and the like.

The eNB 105 may be an example of a base station, and may manage a wireless network within a predetermined range. Hereinafter, embodiments of the present invention will be described based on an eNB as an example of a base station, but the embodiments of the present invention may not be limited thereto.

In a CC operating process in which the eNB 105 adds or removes a CC, a single CC may be added or removed, and a plurality of CCs may be added or removed. Also, the eNB 105 may change a characteristic of a currently used CC (step S110).

In the CC operating process (step S110), the eNB 105 may control a measurement process with respect to CC bands that can be provided by the performance of a UE 100, an adjacent cell, a signal of an overlapping heterogeneous network, and the like. The operation may be performed between the eNB 105 and the UE 100, frequently or at predetermined intervals.

According to an embodiment of the present invention, the eNB 105 and the UE 100 may transmit and receive a packet data by a general operation through an existing downlink (DL)/Uplink (UL) CC (step S111).

The UE 100 may transmit measurement reports to the eNB 105. The transmission of the measurement reports may be embodied in a way in which the UE 100 is triggered by the eNB 105. The triggering may be included in a measurement controlling process that is performed by the eNB 105 to check a current communication status of the UE 100.

Accordingly, based on the measurement controlling by the eNB 105, the UE 100 may measure a signal status of adjacent cells with respect to CC band where a serving cell is able to provide a service, a heterogeneous frequency band, or a homogenous frequency band, and may transmit a status measurement value between the UE 100 and an adjacent wireless network.

Based on the information transmitted by the UE 100, the eNB 105 may determine whether to add a new CC to the UE 100 or to remove a previously allocated CC by changing a current CC configuration, or may determine whether the UE 100 requests a separate CC. In the CC operating process, the UE 100 may transmit a measurement report message by separately including information that requests a CC in the measurement report message, which may correspond to a type of a scheduling request.

Also, the UE 100 may request removal of a previously allocated CC, or may request changing of a characteristic of a current CC. Examples of the characteristic of a CC may include whether a corresponding CC is in charge of a UL or a DL, whether a corresponding CC corresponds to a BC CC or an NBC CC, and the like. Here, the BC CC and the NBC CC may be one of the characteristics of a corresponding CC. CCs may be distinguished as a BC CC that supports LTE which is one of the conventional systems, and an NBC CC that fails to be compatible with the conventional system. Also, when a corresponding CC is a CC that transmits and receives main information associated with CC reconfiguration, the function of the CC may be the characteristic of the CC.

The eNB 105 may determine whether to perform CC reconfiguration of the UE 100 by taking into consideration a situation in which the eNB 105 uses CCs in combination based on the measurement report received from the UE 100 (step S114). That is, whether the current CC operation is effective, whether CC reconfiguration is to be performed, and the like may be determined.

The eNB 105 may independently determine whether to additionally add a CC to a predetermined UE 100, to remove a CC from the UE 100, or to change a CC, based on the situation in which the eNB 105 uses all CCs, or may determine whether to perform additional allocation, removal, or changing of a CC, based on a request from the UE 100.

Also, the measurement report transmission from the UE 100 may transmit information associated with a priority of data to be transmitted from the UE 100 to the eNB 105 and an amount of the data, or may transmit scheduling request information to request resources for transmitting the information along with the information. Also, the UE 100 may directly include the scheduling request information that requests changing of a CC, adding a CC, removal of a CC, and the like in the measurement report, for transmission.

The eNB 105 may select one of existing CCs and transmit a CC reconfiguration message to the UE 100, so as to transfer, to the UE 100, information associated with the CC reconfiguration determined in step S114 (step S115).

The eNB 105 may transmit the information associated with the CC reconfiguration by selecting a predetermined cell, such as an anchor carrier, a serving cell, and a special cell, from among the plurality of CCs, or through use of a previously appointed cell. The CC reconfiguration message may include information associated with which CC is to be allocated or removed, which CC is to be changed, or the like.

When a plurality of CCs are used, ordinary data transmission and reception and main information transmission and reception may be separately performed. The main information transmission and reception may include a pair of a DL CC and a UL CC that provides a function of transmitting and receiving control information that manages radio resources through use of a predetermined CC or a cell, a function of managing a mobility and a security between the UE 100 and the eNB 105, and a function of setting a security associated with data and control information, and the like. Although only one predetermined cell may be defined in a single eNB 105 in an embodiment of the present invention, two or more predetermined cells may be appointed based on a CC configuration. The predetermined cell may be referred to as a primary cell (PCell), and a cell different from the predetermined cell may be referred to as a secondary cell (SCell).

According to an embodiment of the present invention, information associated with or required for CC reconfiguration may be included in a message that is to generated in association with a wireless signal occurring between a UE and an eNB for radio resource control (RRC) (step S115). An RRC connection reconfiguration message (RRC.Conn.Reconf. or RRCConnectionReconfiguration) may be an example of a message that is to perform reconfiguration based on information set in association with the wireless signal occurring during an RRC process. Information associated with CC is reconfiguration may be included in a message that is transmitted and received for RRC between an eNB and a UE, and information associated with the reconfiguration may be transmitted and received through a separate RRC-related message. As another example, a message used in a radio link control (RLC) may correspond to a message that transmits the information associated CC reconfiguration.

Throughout the specifications and drawings, L1 denotes a physical layer, L2 denotes a media access control (MAC) layer, and L3 denotes an RRC layer.

Examples of information that may be included in the RRC connection reconfiguration message (RRCConnectionReconfiguration) may include information associated with a CC to be newly allocated or removed, information associated with whether a corresponding CC is a BC CC or an NBC CC, and the like. Also, a CCReconfigurationInformation parameter may be further included, so as to allocate information associated with a CC. Also, a separate parameter or a separate message may be used.

Also, an operation of changing a characteristic of a CC may be requested. Examples of the characteristic of a CC may include whether a corresponding CC is in charge of a UL or a DL, whether a corresponding CC is a BC CC or an NBC CC, and the like. Also, when a corresponding CC is a CC that transmits and receives main information associated with CC reconfiguration, the function of the CC may additionally include the characteristic information of the CC.

Also, a portion of the information associated with a CC to be reconfigured may be transmitted, or only information that the corresponding CC is to be reconfigured may be transmitted when a corresponding UE includes information associated with the CC to be reconfigured, in advance.

When CC reconfiguration is completed in step S116, that is, when the CC is reconfigured, the UE 100 may transmit a message (ConnectionReconfigurationComplete, RRCConn.Reconf.Complete) indicating that the CC reconfiguration is completed, and the eNB 105 may receive the message as a response message (step S118).

The response message may be transmitted and received through use of a predetermined CC, an anchor CC, a serving cell, a special cell, and the like, or may be transmitted and received through use of a CC that is different from a reconfigured CC. Also, when a reconfiguration process that allocates a new CC to a UL is performed, a CC that is reconfigured to enable the UL to transmit information through the allocated CC may be set as a UL resource. Also, this may enable checking whether data is smoothly transmitted and received in the newly allocated CC.

When a number of newly allocated CCs is two or more, resource allocation for transmission of CC reconfiguration complete information may be set for each of the newly added CCs, whether resource allocation is performed may be determined based on a role of a CC, resource allocation may be performed to one of the added CCs as a representative, or a result of the resource allocation may be transmitted and received through use of a predetermined CC that is in charge of transmission and reception of control information for CC configuration or through use of an anchor CC, a serving cell, or a special cell. This may be changed based on a characteristic of an allocated CC.

For example, when two CCs are allocated and one is for a UL and the is other is for a DL, a CC that performs only UL based on a corresponding role may transmit the CC reconfiguration complete information.

According to another embodiment of the present invention, the UE 100 may transmit the information by allocating a UL through use of one of the existing CCs.

Examples of the information that may be included in the CC reconfiguration complete message (RRCConn.Reconf.Complete) indicating completion of the allocation of a CC in step S118, may include information associated with a CC to be reconfigured, which is included in the CC reconfiguration information (CCReconfigurationInformation) transferred by the eNB 105 to the UE 100 in step S115. That is, information associated with adding or removal of a CC, changing a characteristic of a CC, and the like may be included. Examples of the information of a CC may include an L1 indicator of each CC, information associated with a set or a subset of CCs, upper layer information to be used for distinguishing each CC from among CC system information, and other information.

When step S118 is completed, the UE 100 and the eNB 105 may mutually recognize the completion of the allocation of a CC. That is, a characteristic of a corresponding CC, that is, whether the corresponding CC is in charge of a UL or a DL, whether the corresponding CC is a BC CC or an NBC CC, and the like, may be recognized. Also, when the corresponding CC is a CC that transmits and receives main information associated with CC reconfiguration, a function of the predetermined CC may be recognized.

Subsequently, the UE 100 and the eNB 105 may transmit and receive packet data in the reconfigured CC (step S119).

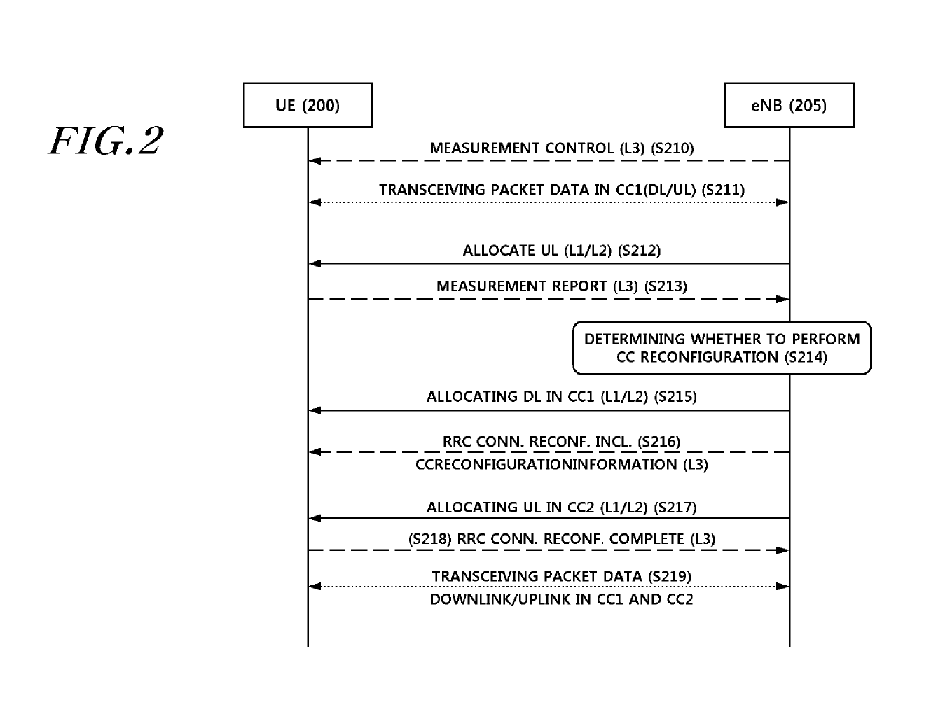

FIG. 2 illustrates a process of additionally allocating a CC according to an embodiment of the present invention.

Referring to FIG. 2, a reconfiguration process that additionally sets CC2 in a CC operating environment where a single CC (CC1) is allocated and utilized, so as to allocate, to a UE, a BC CC or an NBC CC corresponding to a pair of a DL and a UL.

A single CC (CC1) may be allocated to a UE 200 of FIG. 2, and DL and UL may be operated in CC1. CC1 is merely an example in FIG. 2, and the UE may use a plurality of CCs according to another embodiment. That is, to transmit and receive main information in FIG. 2, signaling of CC1 may be performed through another CC. The other CC may be a CC on which a main connection signaling with a UE is set, a predetermined cell such as an anchor CC, a serving cell, or a special cell, and a previously appointed CC.

In a measurement control (MC) process (step S210), the eNB 205 may control measurement with respect to CC bands that can be provided by the performance of a UE 200 an adjacent cell, a signal of an overlapping heterogeneous network, and the like. Here, the corresponding MC information may include system information associated with the CC bands, the adjacent cell, and the overlapping heterogeneous network.

Both the DL/UL in general operations of the eNB 205 and the UE 200 may receive and transmit packet data through CC1 (step S211), and a UL resource may be allocated from the eNB 205 so as to transmit a measurement value measured in the MC process in step S210 (step S212). The UE 200 may transmit measurement reports to the eNB 205 through the allocated UL resource (step S213). The eNB 205 may is determine whether to perform CC reconfiguration with respect to the UE 200 by taking into consideration a situation in which the eNB 205 uses CCs in combination based on the measurement reports received from the UE 200 (step S214). In FIG. 2, the eNB 205 may determine whether to add a DL/UL CC. Here, adding the CC may include adding one or more CCs.

The eNB 205 may select one of the existing CCs (CC1 in FIG. 2) and may allocate a DL resource, so as to transfer information associated with the CC reconfiguration determined in step S214 (step S215). In this example, the transmission may be performed through use of one of a plurality of CCs or a previously appointed CC.

The CC reconfiguration information and information required for CC reconfiguration may be transmitted to the DL resource allocated in step S215 (step S216). Examples of the information required for the reconfiguration may be an RRC connection reconfiguration (RRCConnectionReconfiguration) message, and other messages. In the message, all of CC configuration information may be included, and only a portion of the reconfiguration information may be included.

Examples of the information that may be included in the RRC connection reconfiguration message (RRCConnectionReconfiguration) may include information associated with a newly allocated CC, for example, CC2, information associated with whether a corresponding CC is a BC CC or an NBC CC, and the like. Also, information required for allocating a CC may be set as a CCReconfigurationInformation parameter. Also, a separate parameter or a separate message may be used.

Also, when a portion of information associated with a CC to be allocated may be transmitted, and only information that a corresponding CC is to be allocated may is be transmitted when a corresponding UE includes information associated with the CC to be allocated, in advance.

When CC reconfiguration is completed in step S216, a resource of the allocated UL CC (CC2) may be allocated (step S217). According to an embodiment of the present invention, through a DL channel of the existing CC (CC1) which is used before the new CC (CC2) is allocated, the resource of the newly allocated UL CC (CC2) may be allocated for transmission of CC reconfiguration complete information. This may enable checking whether data is smoothly transmitted and received in the newly allocated CC (CC2).

When a number of newly added CCs is two or more, resource allocation for transmission of the CC reconfiguration complete information may be set for each of the newly added CCs, whether resource allocation is performed may be determined based on a role of a CC, resource allocation may be performed to one of the added CCs as a representative, or an existing CC may be used.

For example, when two CCs are allocated and one is for a UL and the other is for a DL, a CC that performs only UL based on a corresponding role may transmit the CC reconfiguration complete information.

According to another embodiment of the present invention, It may be performed by a cell/carrier that is in charge of signaling control information, such as an anchor carrier, a serving cell, and a special cell, as described in the embodiment provided before the CC that allocates a UL. Therefore, the eNB 205 may configure UL resource allocation information of step S217 indicating that the UL resource is allocated to the anchor carrier, the serving cell, or the special cell, and the UE 200 may transmit a result is of CC reconfiguration through the allocated UL resource.

Unlike step S216, step S217 is associated with an L1/L2 signaling, and a time of starting step S217 may be the same as step S216 or may be immediately after the competition of step S216. Timing of the L1/L2 signaling in the process may be based on a general rule of a corresponding wireless communication system.

In step S218, the UE 200 may transmit a CC reconfiguration complete message (RRCConn.Reconf.Complete) indicating that allocation of a CC is completed, through an upload link allocated in step S217. Examples of information that may be included in the CC reconfiguration complete message may include characteristic information of a DL/UL CC which is included in the CC reconfiguration information (CCReconfigurationInformation) that the eNB 205 transmits to the UE 200 step S216. Desirably, the characteristic information may be an L1 indicator of each CC, may be information associated with a set or subset of CCs, may be upper layer information to be used for distinguishing each CC from among CC system information, or may be other information. When step S218 is completed, the UE 200 and the eNB 205 may mutually recognize that the allocation of a CC is completed.

Subsequently, the UE 200 and the eNB 205 may transmit and receive packet data in a DL/UL through use of one or more added DL/UL CCs and one or more existing CCs (step S219).

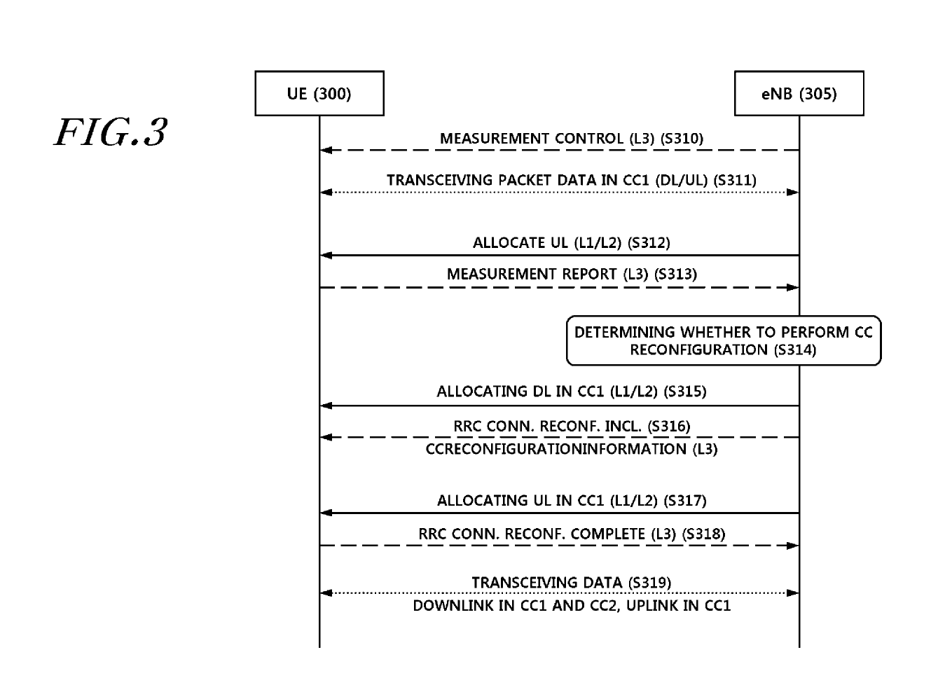

FIG. 3 illustrates a process of additionally allocating a DL non-backward compatible (NBC) CC according to an embodiment of the present invention.

In FIG. 3, an MC process (step S310), a process of transmitting and receiving information in CC1 (step S311), a process of allocating a UL to enable a UE 300 to transmit a measurement report (step S312), and a process in which the UE 300 transmits the measurement report to an eNB 305 (step S313) may be understood based on the description provided with reference to FIG. 2.

The eNB 305 may determine whether to perform CC reconfiguration with respect to the UE 300 by taking into consideration of a situation in which the eNB 305 uses CCs in combination based on a result of the measurement report received in step S313. In FIG. 3, the eNB 305 may determine whether to add a DL CC. Adding a CC may include adding one or more CCs (step S314).

The eNB 305 may select one of the existing CCs configured in the UE 300, for example, CC1, and may allocate a DL resource, so as to transfer information associated with the CC reconfiguration determined in step S314 (step S315). Also, the allocation of the DL resource may be performed through use of a CC that is selected by an eNB from among a plurality of CCs or a previously appointed CC.

The eNB 305 may transmit the CC reconfiguration information and information required for the CC reconfiguration to the DL resource allocated in step S315 through CC1. The information required for the reconfiguration may be transmitted through an RRC connection reconfiguration message (RRCConnectionReconfiguration), and may be transmitted through other messages. In the message, all information related to CC configuration information may be included, and only a portion of the reconfiguration information may be included. Also, only information that a corresponding CC is to be allocated may be transmitted when a corresponding UE includes information associated with the CC to be allocated, in advance (step S316).

In more particular, the RRC connection reconfiguration message (RRCConnectionReconfiguration) may include information associated with a DL NBC CC to be newly allocated, for example, CC2, and may further include parameters corresponding to information required for allocating CC2.

When the CC reconfiguration is completed, the eNB 305 may need to transmit CC reconfiguration complete information through use of the existing CC1 in which DL is performed. To achieve the above, a resource of an existing UL CC (CC1) may be allocated (step S317).

When a number of newly added CCs is two or more, resource allocation for transmission of the CC reconfiguration complete information may be set for each of the newly added CCs, a resource may be allocated to one of the added CCs as a representative, or an existing CC may be used.

According to another embodiment of the present invention, a resource allocation may be performed through a cell/carrier that is in charge of signaling control information, such as an anchor carrier, a serving cell, or a special cell, as described in an embodiment provided before the description of the CC that allocates a UL. Therefore, the eNB 305 may configure UL resource allocation information of step S317 through the anchor carrier, the serving cell, or the special cell, and the UE 300 may transmit a result of the CC reconfiguration through use of the allocated UL resource.

Unlike step S316, step S317 is associated with an L1/L2 signaling, a time of starting step S317 may be the same as step S316, or may be immediately after the completion of step S316. Timing of the L1/L2 signaling in the process may be based on a general rule of a corresponding wireless communication system.

In step S318, the UE 300 may transmit, to the eNB 305, a CC is reconfiguration complete message (RRCConn.Reconf.Complete) that may indicate that allocation of a CC is completed, through the allocated upload link. The CC reconfiguration complete message may include characteristic information of a DL CC, which is included in the CC reconfiguration information (CCReconfigurationInformation) that is transferred from the eNB 305 to the UE 300 in step S316. The characteristic information may be an L1 indicator of each CC, may be information associated with a set or a subset of CCs, may be upper layer information to be used for distinguishing each CC from among CC system information, and may be other information.

When step S318 is completed, the UE 300 and the eNB 305 may mutually recognize that the allocation of a CC is completed.

Subsequently, the UE 300 and the eNB 305 may transmit and receive packet data in a DL/UL through use of one or more added DL CCs and one or more existing CCs (step S319). In more particular, packet data may be received through the one or more added DL CCs and DLs of one or more existing CCs, and packet data may be transmitted through use of a existing UL CC(s).

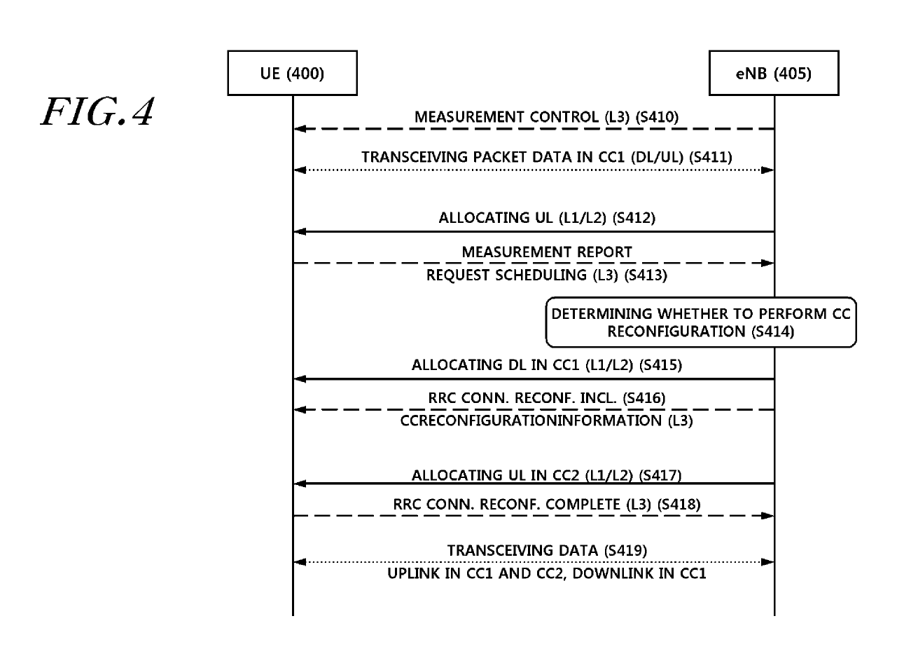

FIG. 4 illustrates a process of additionally allocating a UL NBC CC according to an embodiment of the present invention.

FIG. 4 describes a process of additionally setting a UL NBC CC (CC2) for a UE 400 that sets and uses a single CC, for example, CC1. Here, an MC process (step S410), a process of transmitting and receiving information through CC1 (step S411), a measurement report process (step S412) may be understood based on the description with reference to FIG. 2. In particular, a UL setting process of FIG. 4 may include a process is in which a UL is set in response to a request from the UE 400 (step S413).

The UE 400 may transmit a scheduling request message to request allocation of a resource required for transmitting a measurement report to an eNB 405 and for sending data to be transmitted in a UL (step S413). The scheduling request message may include information associated with a total amount of current data to be transmitted in a UL, information associated with a total amount of data having a high priority, or may include a portion of the information. Also, information associated with a period (time) in which a UL is to be maintained.

The eNB 405 may determine whether to perform CC reconfiguration with respect to the UE 400 by taking into consideration a situation in which the eNB 405 uses CCs based on a result of the measurement report received from the UE 400 and the scheduling request message from the UE 400. That is, the eNB 405 may determine to add a UL CC. Adding a CC may include adding one or more CCs (step S414).

The eNB 405 may select one of the existing CCs configured in the UE 400, for example, CC1 in FIG. 4, and may allocate a DL resource, so as to transfer information associated with the CC reconfiguration determined in step S414 (step S415). Also, the allocation of the DL resource may be performed through use of a CC from among a plurality of CCs or a previously appointed CC.

The CC reconfiguration information and information required for CC reconfiguration may be transmitted to the DL CC allocated in step S415 (step S416). The information required for the reconfiguration may be transmitted through an RRC connection reconfiguration message (RRCConnectionReconfiguration), and may be transmitted through other messages. In the message, all of CC configuration information is may be included, and only a portion of the reconfiguration information may be included. Also, only information that a corresponding CC is to be allocated may be transmitted when a corresponding UE includes information associated with the CC to be allocated, in advance.

The RRC connection reconfiguration message (RRCConnectionReconfiguration) may include information associated with a CC to be newly allocated, for example, CC2, and a CCReconfigurationInformation parameter corresponding to information required for allocating the CC. Also, a separate parameter or a separate message may be used.

When the CC reconfiguration is completed, a resource of the newly allocated UL CC (CC2) may be allocated (step S417). When a number of the newly added CCs is two or more, resource allocation for transmission of CC reconfiguration complete information may be set for each of the newly added CCs. Whether resource allocation is performed may be determined based on a role of the CC, a resource may be allocated to one of the added CCs as a representative, or an existing CC may be used.

The eNB 405 may configure UL resource allocation information of step S417 indicating that the UL resource is allocated to the anchor carrier, the serving cell, or the special cell, and the UE 400 may transmit a result of the CC reconfiguration through use of the allocated UL resource.

The UE 400 may transfer a CC reconfiguration complete message (RRCConn.Reconf.Complete) to the eNB 405, based on the information transferred in step S417 (step S418). Here, the CC reconfiguration complete message (RRCConn.Reconf.Complete) may include characteristic information of the added UL CC. When step S418 is completed, the UE 400 and the eNB 405 may mutually recognize that the CC reconfiguration is completed.

Packet data may be transmitted through the added UL CC(s) (CC2) and a UL of the existing CC(s) (CC1), and packet data may be received through the existing DL CC(s) (CC1) (step S419).

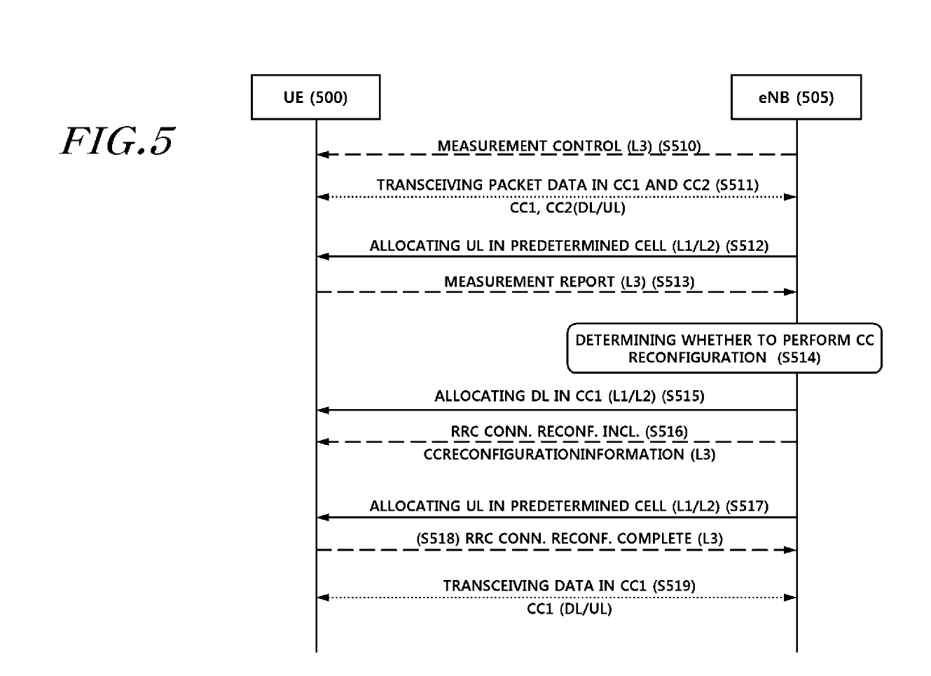

FIG. 5 illustrates processes for removing a CC according to an embodiment of the present invention. Here, a description of processes corresponding to steps S510 through S513, which may be understood based on the corresponding processes described with reference FIG. 2, will be omitted.

Referring to FIG. 5, an eNB 505 may determine whether to perform CC reconfiguration with respect to a UE 500 by taking into consideration a situation in which the eNB 505 uses CCs based on a result of a measurement report (step S514). In FIG. 5, whether to remove both a DL and a UL or to remove one of the DL and the UL may be determined.

The eNB 505 may select one of the existing CCs for the UE 500, for example, CC1 in FIG. 5, and may allocate a DL resource so as to transfer, to the UE 500, information associated with CC reconfiguration determined in step S514 (step S515). Also, the allocation of the DL resource may be performed through use of a CC from among a plurality of CCs, a predetermined cell such as an anchor carrier, a serving cell, and a special cell, or a previously appointed CC.

The CC reconfiguration information and information required for the CC reconfiguration may be transmitted to the DL resource allocated in step S515 (step S516). The information required for the reconfiguration may be transmitted through an RRC is connection reconfiguration message (RRCConnectionReconfiguration), or other messages. In the message, all of CC configuration information may be included or a portion of the CC reconfiguration information may be included.

The RRC connection reconfiguration message (RRCConnectionReconfiguration) may include information associated with a CC to be removed, for example, CC2, and a CCReconfigurationInformation parameter corresponding to information required for removing the CC.

Here, a portion of the information associated with the CC to be removed may be transmitted, and only information that the corresponding CC is to be removed may be transmitted when a corresponding UE includes information associated with the CC to be removed, in advance.

When the CC reconfiguration is completed, the UE 500 may allocate, through an existing DL CC, a resource for transmission of CC reconfiguration complete information (step S517).

According to another embodiment of the present invention, resource for transmission and reception of control information may be allocated in a DL and a UL to a cell/carrier that is in charge of signaling control information, such as an anchor carrier, a serving cell, and a special cell, as described in the embodiment provided before the CC that allocates a UL. Accordingly, the UL of step S517 may be allocated to the anchor cell, the serving cell, or the special cell, the UE 500 may receive a result of the CC reconfiguration in the allocated UL.

The UE 500 may transfer, to the eNB 505, a CC reconfiguration complete is message (RRCConn.Reconf.Complete) that indicates that removal of a CC is completed, based on the information transferred in step S517 (step S518). Here, the CC reconfiguration complete message may be characteristic information of a removed DL/UL CC or characteristic information of one of a removed DL CC and a removed UL CC.

When step S518 is completed, the UE 500 and the eNB 505 may mutually recognize that the CC reconfiguration is completed. Packet data may be transmitted and received through a DL/UL of a remaining existing CC(s) excluding the removed DL/UL CC(s) (step S519).

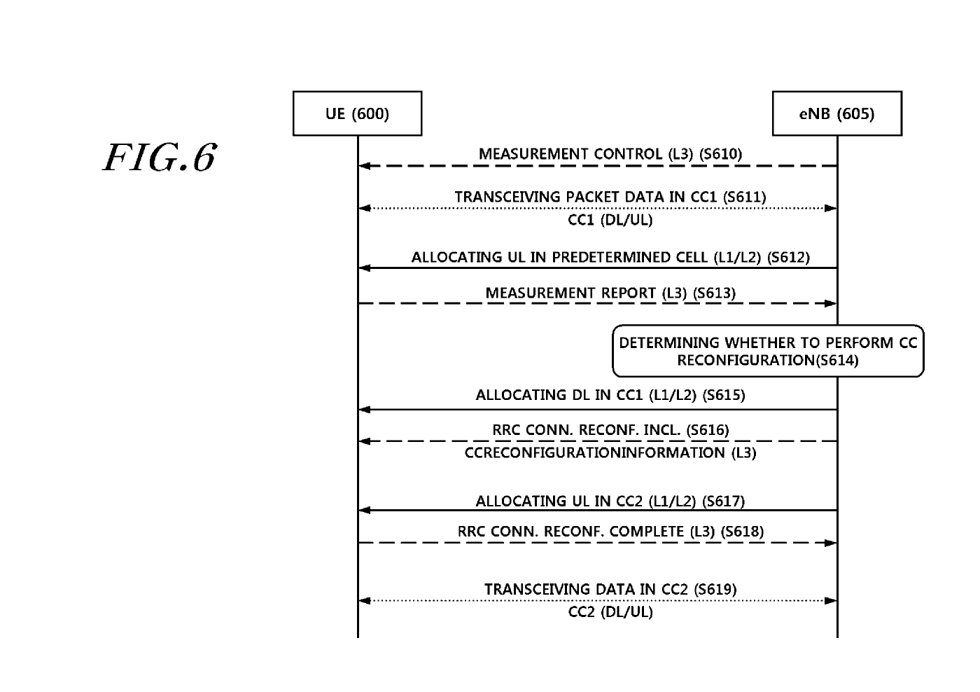

FIG. 6 illustrates processes for changing a location of a CC according to an embodiment of the present invention.

Referring to FIG. 6, a process that newly allocates a single CC and removes a previous CC may be provided. A UE that uses two or more CCs may remove a currently used CC, and may receive allocation of a new CC. Hereinafter, a description of processes corresponding to steps 610 through 613, which may be understood based on the description with reference to FIG. 2, will be omitted.

The eNB 605 may determine whether to perform CC reconfiguration with respect to a UE 600 by taking into consideration a situation in which the eNB 605 uses CCs based on a result of a measurement report (step S614). In FIG. 6, whether to perform changing a location where a CC is used, whether to change a location where a CC is used based on a scheme of allocating a CC first and removing a CC, or whether to change a location where a CC is used based on a scheme of removing a CC first and then newly allocating a CC, and the like, may be determined. Changing the location of the CC is may include changing locations of one or more CCs. In FIG. 6, a CC is newly allocated first and then an existing CC is removed.

The eNB may select one of the existing CCs for the UE 600, for example, CC1 of FIG. 6, and a DL resource may be allocated, so as to transfer, to the UE 600, information associated with the CC reconfiguration determined in step S614 (step S615).

The CC reconfiguration information associated with a CC that is to be allocated and a CC that is to be removed, of step S615, and information required for the CC reconfiguration may be transmitted (step S616). The information required for CC reconfiguration may be transmitted through an RRC connection reconfiguration message (RRCConnectionReconfiguration), or may be transmitted through other messages. In the message, all of CC configuration information may be included, or only a portion of the reconfiguration information may be included. Here, the RRC connection reconfiguration message (RRCConnectionReconfiguration) may transmit a portion of information associated with a CC to be removed (CC1), or may transmit only information that the corresponding CC is to be removed when a corresponding UE includes information associated with the CC to be removed, in advance.

When the CC reconfiguration associated with a CC of which a location is to be changed is completed, the UE 600 may allocate a resource for transmitting CC reconfiguration complete information, through a newly allocated CC (step S617).

When adding a new CC (CC2) is completed based on the information transferred in step S617, the UE 600 may transfer, to the eNB 605, a CC reconfiguration complete message (RRCConn.Reconf.Complete) that indicates a location where a CC is used is changed from the existing CC1 (step S618). Here, the CC reconfiguration is completion message may include characteristic information of the newly added CC and the removed CC. The characteristic information may be an L1 indicator of each of the added CC and the removed CC, may be information associated with a set or a subset of CCs, may be upper layer information for distinguishing each CC from among CC system information, and may be other information.

When step S618 is completed, the UE 600 and the eNB 605 may mutually recognize that the CC reconfiguration is completed. Data may be transmitted and received in the newly allocated CC (CC2), and data may not be transmitted and received in the removed existing CC (CC1) any longer (step S619).

FIG. 6 describes a process of changing a location in which a CC is used, by allocating a new CC and removing an existing CC. However, when a UE uses two or more CCs, and performs changing a location where a CC is used with respect to one of the CCs, reconfiguration that removes the corresponding CC and allocates a new CC may be performed.

In FIGS. 1 through 6, an eNB may be configured to include a transmitting unit and a receiving unit which perform transmission and reception of a message including information with a UE, and to include a message generating unit to generate an RRC message and a controller to control generation of a message and transmission and reception.

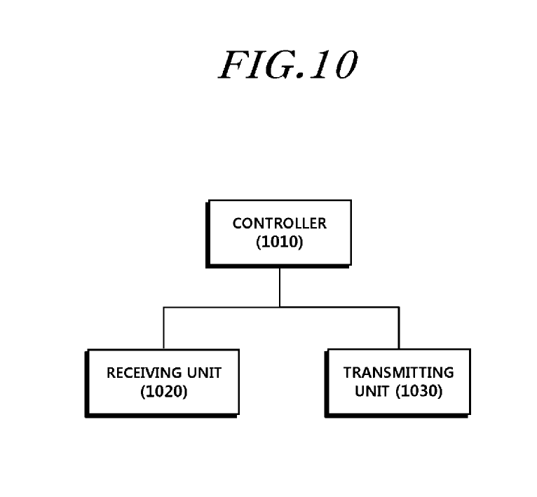

Referring to FIG. 10, the eNB may be configured as follows.

For example, the receiving unit may receive a message including information associated with a CC from the UE. The controller may determine whether to perform CC reconfiguration based on the information included in the message received by the receiving unit, and may control the message generating unit to generate a reconfiguration message including information associated with a CC to be reconfigured in the UE. Also, the controller may transmit the generated message to the UE through the transmitting unit, and may control the transmitting unit and the receiving unit to perform transmission and reception of data with the UE based on a configuration of the reconfigured CC.

Also, to measure a communication environment of the UE, the eNB may transmit a message to control measurement of the communication environment of the UE, and may receive a message including a measurement result in response to the transmitted message. Also, a response message of the UE may be received in response to a result of the CC reconfiguration. The eNB may include information associated with a CC to be allocated to the UE in the reconfiguration message, so as to allocate a DL or UL CC.

According to another embodiment of the present invention, an eNB may include a transmitting unit to determine whether to perform CC reconfiguration with respect to the UE and to transmit, to a UE, a reconfiguration message including information associated with a UL CC to be allocated in a cell, a controller to allocate a resource included in the cell as a UL CC resource, and a receiving unit to receive, from the UE, a result message including a result of the allocation of the UL CC. The controller may control the receiving unit to receive the result message through the allocated UL CC.

According to another embodiment of the present invention, an eNB may include a receiving unit to receive a message including information associated with a CC from a UE, a controller to determine whether to perform CC reconfiguration based on is information included in the message, a message generating unit to generate a reconfiguration message including information associated with a CC to be reconfigured in the UE, and a transmitting unit to transmit the generated message to the UE. The controller may control the transmitting unit and the receiving unit so as to perform transmission and reception of data with the UE, based on a configuration of the reconfigured CC. The information associated with the CC to be reconfigured may allocate a resource in a cell to a UL CC or DL CC, or may instruct the UE to remove the UL CC or the DL CC allocated to the resource in the cell.

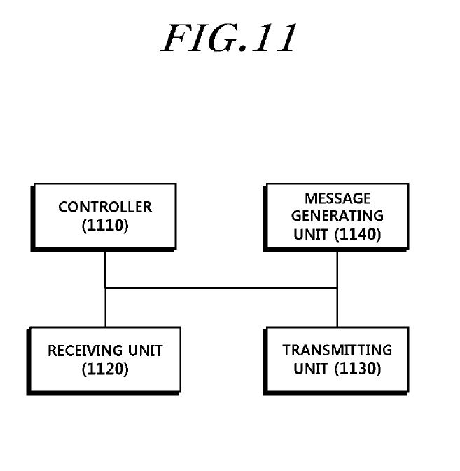

Referring to FIG. 11, a UE may be configured as follows.

According to another embodiment of the present invention, a UE may include a receiving unit to receive a reconfiguration message including information associated with a UL CC to be allocated to a cell, a controller to allocate a resource in the cell as a UL CC resource, and a transmitting unit to transmit, to the eNB, a result message including a result of the allocation of the UL CC. The controller may control the transmitting unit to transmit the result message through the allocated UL CC.

According to another embodiment of the present invention, a UE may include a message generating unit to generate a message including information associated with a CC, a transmitting unit to transmit the generated message to an eNB, a receiving unit to receive, from the eNB, a reconfiguration message including information associated with a CC to be reconfigured, and a controller to control the message generating unit, the transmitting unit, and the receiving unit. The message generating unit may generate a reconfiguration response message including a result of the reconfiguration, in response to the received reconfiguration message. The controller may is transmit the reconfiguration response message to the eNB, and may control the transmitting unit and the receiving unit so as to perform transmission and reception of data with the eNB based on a configuration of the reconfigured CC. The information associated with the CC to be reconfigured may allocate a resource in a cell to a UL or DL CC, or may instruct the UE to remove the UL or DL CC allocated to the resource in the cell.

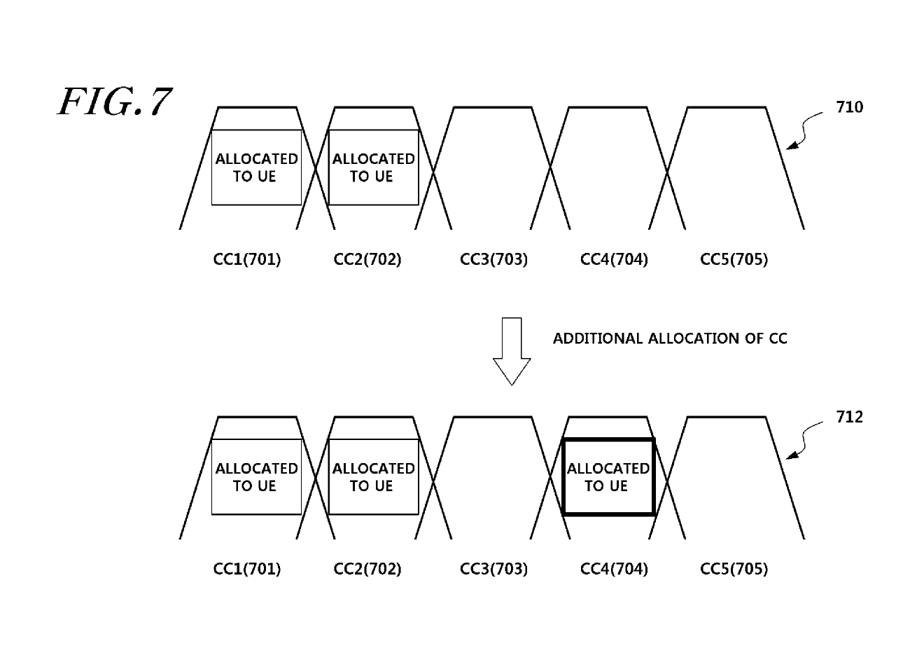

FIG. 7 illustrates an example of operating CCs by newly allocating a CC according to an embodiment of the present invention.

Referring to FIG. 7, CC1 701 and CC2 702 are allocated to a UE in a state 710. When a CC is added, that is, CC4 704 is newly allocated as shown in a state 712, the UE may be capable of using CC1, CC2, and CC4 as CCs.

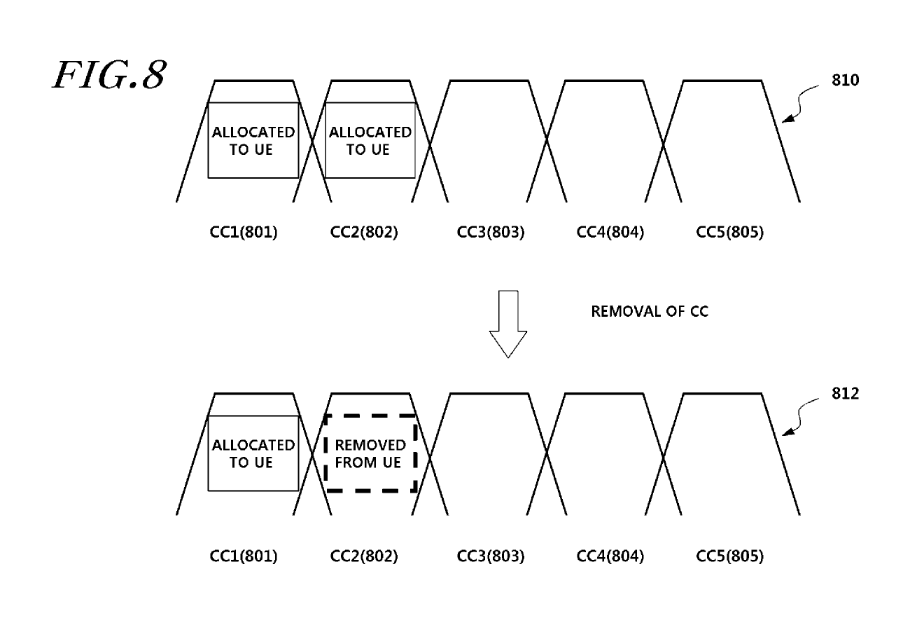

FIG. 8 illustrates an example of operating CCs by removing a CC according to an embodiment of the present invention.

Referring to FIG. 8, CC1 801 and CC2 802 are allocated to a UE in a state 810. When a currently used CC is removed, that is, when CC2 802 is removed from the UE as shown in state 812, the UE may use only CC1 as a CC.

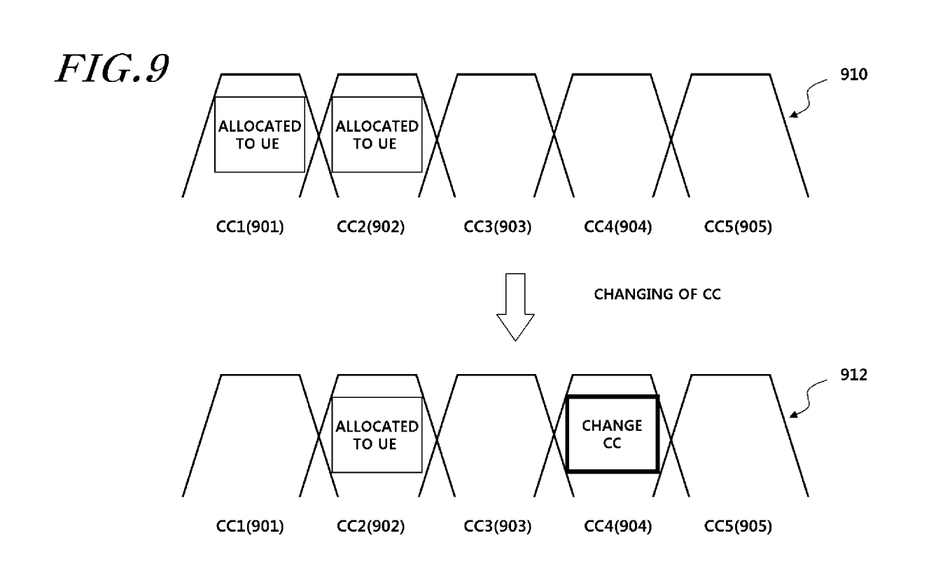

FIG. 9 illustrates an example of operating CCs by changing a CC according to an embodiment of the present invention.

Referring to FIG. 9, CC1 901 and CC2 902 are allocated to a UE in a state 910. In this example, a currently used CC may be changed from CC1 901 to CC4 904. Here, changing a CC may include that data transmission and reception in CC1 901 is performed in CC4 904 of a different frequency band, and that data transmission and reception is no longer performed in CC1 901.

FIG. 10 illustrates a configuration of an e-Node B (eNB) that operates CCs by changing a CC according to an embodiment of the present invention.

The eNB of FIG. 10 may be configured to include a controller 1010, a receiving unit 1020, and a transmitting unit 1030.

In particular, the controller 1010 may determine whether to perform CC reconfiguration with respect to a UE, and may generate an RRC connection reconfiguration message including information associated with a UL CC to be allocated in a second cell for the UE.

The transmitting unit 1030 may transmit the RRC connection reconfiguration message using one of a first cell and the second cell. Subsequently, the controller 1010 may allocate a resource in the second cell as a UL CC resource.

Through the UL CC allocated in the second cell, the receiving unit 1020 may receive, from the UE, a CC reconfiguration complete message including a result of the allocation of the UL CC. Here, the first cell may be one of a cell on which the eNB sets a main connection signal with the UE, a predetermined cell, and a previously appointed cell. In particular, the first cell corresponds to a primary cell, and the second cell corresponds to a secondary cell.

As described in the embodiments of FIGS. 3, 4, 5, and 6, the eNB may allocate the resource in the second cell as a resource of a UL or DL CC, or may remove or change a resource of the allocated UL or DL CC. In addition, the eNB may further include a message generating unit, separately from the controller.

According to an embodiment of the present invention, the receiving unit 1020 may receive a message including information associated with a CC from the UE, and the controller 1010 may determine whether to perform CC reconfiguration with respect to a secondary cell based on the information included in the message.

When the message generating unit generates an RRC connection reconfiguration message including information associated with a CC to be reconfigured in the UE, the transmitting unit 1030 may transmit the generated message to the UE through a primary cell or the secondary cell.

In this example, the controller 1010 may control the receiving unit 1020 to receive a CC reconfiguration complete message including a reconfiguration result of the reconfigured CC from the UE, and may also control the transmitting unit 1030 and the receiving unit 1020 to perform transmission and reception of data with the UE based on a configuration of the reconfigured CC. Also, the controller 1010 may provide a function of the message generating unit.

FIG. 11 illustrates a configuration of a UE that operates CCs by changing a CC according to an embodiment of the present invention.

Referring to FIG. 11, the UE may be configured to include a controller 1110, a receiving unit 1120, and a transmitting unit 1130. Also, the UE may selectively include a message generating unit 1140.

In particular, the receiving unit 1120 may receive, from the eNB, an RRC connection reconfiguration message including information associated with a UL CC to be allocated in a second cell, through one of a first cell and a second cell.

The controller 1110 may receive allocation of the resource in the second cell from the eNB, and may allocate the allocated resource as a UL CC resource. The transmitting unit 1130 may transmit, to the eNB through the UL CC allocated to the is second cell, a CC reconfiguration complete message including a result of the allocation of the UL CC. Here, the first cell may be one of a cell on which the eNB sets a main connection signaling with the UE, a predetermined cell, and a previously appointed cell. In particular, the first cell corresponds to a primary cell, and the second cell corresponds to a secondary cell.

As described in the embodiments of FIGS. 3, 4, 5, and 6, the UE may receive allocation of the resource of the second cell from the eNB and may allocate the resource to a UL or DL CC, or may remove or change the resource of the allocated UL or DL CC. In addition, the UE may further include a message generating unit, separately from the controller.

For example, the message generating unit 1140 may generate a message including information associated with a CC to be reconfigured in a secondary cell, and the transmitting unit 1130 may transmit the generated message to the eNB. The receiving unit 1120 may receive, from the eNB, an RRC connection reconfiguration message including information associated with the CC to be reconfigured, through a primary cell or the secondary cell.

The controller 1110 may control the message generating unit 1140, the transmitting unit 1130, and the receiving unit 1120, and may selectively include the message generating unit 1140 so as to provide a function of the message generating unit 1140. The message generating unit 1140 may generate a CC reconfiguration complete message including a reconfiguration result associated with the received reconfiguration message. The controller 1110 may transmit the CC reconfiguration complete message to the eNB, and may control the transmitting unit 1130 and the receiving unit 1120 so as to perform transmission and reception of data with the eNB based on a configuration of the reconfigured CC.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for an e-Node B (eNB) to operate a component carrier (CC), the method comprising:
determining whether to perform CC reconfiguration with respect to a user equipment (UE), and transmitting, to the UE through use of one of a first cell and a second cell, a radio resource control (RRC) connection reconfiguration message including information associated with an uplink (UL) CC that is to be allocated to the second cell;
allocating a resource in the second cell as a UL CC resource; and
receiving, from the UE through the UL CC allocated to the second cell, a CC reconfiguration complete message including a result of the allocation of the UL CC.

2. The method as claimed in claim 1, wherein the first cell is one of a cell on which the eNB sets a main connection signaling with the UE, a predetermined cell, and a previously appointed cell.

3. The method as claimed in claim 2, wherein the first cell corresponds to a primary cell, and the second cell corresponds to a secondary cell.

4. The method as claimed in claim 1, wherein, before transmitting of the RRC connection reconfiguration message, the method further comprises:
transmitting, by the eNB in the first cell to the UE, a measurement control (MC) message to control measurement of a communication environment of the UE; and
receiving, by the eNB in the first cell from the UE, a measurement report message including a measurement result associated with the MC message.

5. The method as claimed in claim 1, wherein the RRC connection reconfiguration message further includes information instructing removal of a UL CC allocated to a third cell that is different from the second cell; and
the method further comprises removing the UL CC allocated to the third cell.

6. A method for a user equipment (UE) to operate a component carrier (CC), the method comprising:
receiving, from an e-Node B (eNB) through use of one of a first cell and a second cell, a radio resource control (RRC) connection reconfiguration message including information associated with an uplink (UL) CC to be allocated to the second cell;
receiving allocation of a resource included in the second cell from the eNB, and allocating the allocated resource as a UL CC resource; and
transmitting, to the eNB through the UL CC allocated to the second cell, a CC reconfiguration complete message including a result of the allocation of the UL CC.

7. The method as claimed in claim 6, wherein the first cell is one of a cell on which the eNB sets a main connection signaling with the UE, a predetermined cell, and a previously appointed cell.

8. The method as claimed in claim 7, wherein the first cell corresponds to a primary cell, and the second cell corresponds to a secondary cell.

9. The method as claimed in claim 6, wherein, before receiving of the RRC connection reconfiguration message, the method further comprises:
receiving, by the UE in the first cell from the eNB, a measurement control (MC) message to control measurement of a communication environment of the UE; and
transmitting, by the UE in the first cell to the eNB, a measurement report message including a measurement result associated with the MC message.

10. The method as claimed in claim 6, wherein the RRC connection reconfiguration message further includes information instructing removal of a CC allocated to a third cell that is different from the second cell; and
the method further comprises removing a UL CC allocated to the third cell.

11. An apparatus for operating a component carrier (CC), the apparatus comprising:
a controller to determine whether to perform CC reconfiguration with respect to a user equipment (UE), to generate a radio resource control (RRC) connection reconfiguration message including information associated with an uplink (UL) CC that is to be allocated to a second cell, for the UE, and to allocate a resource in the second cell as a UL CC resource;
a transmitting unit to transmit the RRC connection reconfiguration message through use of one of a first cell and the second cell; and
a receiving unit to receive, from the UE through the UL CC allocated to the second cell, a CC reconfiguration complete message including a result of the allocation of the UL CC.

12. The apparatus as claimed in claim 11, wherein the first cell is one of a cell on which an e-Node B (eNB) sets a main connection signaling with the UE, a predetermined cell, and a previously appointed cell.

13. The apparatus as claimed in claim 12, wherein the first cell corresponds to a primary cell, and the second cell corresponds to a secondary cell.

14. The apparatus as claimed in claim 11, wherein an eNB transmits, to the UE, a measurement control (MC) message to control measurement of a communication environment of the UE in the first cell, before the transmitting unit transmits the RRC connection reconfiguration message; and
the receiving unit receives, from the UE, a measurement report message including a measurement result associated with the MC message in the first cell.

15. The apparatus as claimed in claim 11, wherein the RRC connection reconfiguration message further includes information instructing removal of a UL CC allocated to a third cell that is different from the second cell; and
the controller removes the UL CC allocated to the third cell.

16. An apparatus for operating a component carrier (CC), the apparatus comprising:
a receiving unit to receive, from an e-Node B (eNB) through use of one of a first cell and a second cell, a radio resource control (RRC) connection reconfiguration message including information associated with an uplink (UL) CC to be allocated to the second cell;
a controller to receive allocation of a resource included in the second cell from the eNB, and to allocate the allocated resource as a UL CC resource; and
a transmitting unit to transmit, to the eNB through the UL CC allocated to the second cell, a CC reconfiguration complete message including a result of the allocation of the UL CC.

17. The apparatus as claimed in claim 16, wherein the first cell is one of a cell on which the eNB sets a main connection signaling with the UE, a predetermined-cell, and a previously appointed cell.

18. The apparatus as claimed in claim 17, wherein the first cell corresponds to a primary cell and the second cell corresponds to a secondary cell.

19. The apparatus as claimed in claim 16, wherein the UE receives, from the eNB, a measurement control (MC) message to control measurement of a communication environment of the UE in the first cell, before the receiving unit receives the RRC connection reconfiguration message; and
the transmitting unit transmits, to the eNB, a measurement report message including a measurement result associated with the MC message in the first cell.

20. The method as claimed in claim 16, wherein the RRC connection reconfiguration message further includes information instructing removal of a UL CC allocated to a third cell that is different from the second cell; and
the controller removes the UL CC allocated to the third cell.

21. A method for an e-Node B (eNB) to operate a component carrier (CC), the method comprising:
determining whether to perform CC reconfiguration with respect to a user equipment (UE), and transmitting, to the UE through use of a first cell, a radio resource control (RRC) reconfiguration message including information associated with a downlink (DL) CC to be allocated to a second cell;
allocating a resource included in the second cell as a DL CC resource; and
receiving, from the UE through an uplink (UL) CC allocated to the first cell or the second cell, a CC reconfiguration complete message including a result of the allocation of the DL CC.

22. A method for an e-Node B (eNB) to operate a component carrier (CC), the method comprising:
determining whether to perform CC reconfiguration with respect to a user equipment (UE), and transmitting, to the UE through use of a first cell or a second cell, a radio resource control (RRC) reconfiguration message including information associated with a downlink (DL) CC to be removed from the second cell;
removing an allocated DL CC resource from the second cell; and
receiving, from the UE through use of an uplink (UL) CC allocated to the first cell or the second cell, a CC reconfiguration complete message including a result of the removal of the DL CC.

23. A method for an e-Node B (eNB) to operate a component carrier (CC), the method comprising:
determining whether to perform CC reconfiguration with respect to a user equipment (UE), and transmitting, to the UE through use of a first cell or a second cell, a radio resource control (RRC) connection reconfiguration message including information associated with an uplink (UL) CC to be removed from the second cell;
removing an allocated UL CC resource from the second cell; and
receiving, from the UE through use of a UL CC allocated to the first cell, a CC reconfiguration complete message including a result of the removal of the UL CC.

24. A method for a user equipment (UE) to operate a component carrier (CC), the method comprising:
receiving, from an e-Node B (eNB) through use of a first cell, a radio resource control (RRC) connection reconfiguration message including information associated with a downlink (DL) CC to be allocated to a second cell;
receiving allocation of a resource included in the second cell from the eNB, and allocating the allocated resource as a DL CC resource; and
transmitting, to the eNB through use of an uplink (UL) CC allocated to the first cell or the second cell, a UL CC reconfiguration complete message including a result of the allocation of the DL CC.

25. A method for a user equipment (UE) to operate a component carrier (CC), the method comprising:
receiving, from the eNB through use of a first cell or a second cell, a radio resource control (RRC) reconfiguration message including information associated with a downlink (DL) CC to be removed from the second cell;
removing the DL CC allocated from the eNB to a resource included in the second cell; and
transmitting, to the eNB through use of an uplink (UL) CC allocated to the first cell or the second cell, a CC reconfiguration complete message including a result of the removal of the DL CC.

26. A method for a user equipment (UE) to operate a component carrier (CC), the method comprising:
receiving, from an e-Node B (eNB) through use of a first cell or a second cell, a radio resource control (RRC) connection reconfiguration message including information associated with an uplink (UL) CC to be removed from the second cell;
removing the UL CC allocated from the eNB to a resource included in the second cell; and
transmitting, to the eNB through use of a UL CC allocated to the first cell, a CC reconfiguration complete message including a result of the removal of the UL CC.

27. An apparatus for operating a component carrier (CC), the apparatus comprising:
a receiving unit to receive, from a user equipment (UE), a message including information associated with a CC;
a controller to determine whether to perform CC reconfiguration with respect to a secondary cell, based on the information included in the message;
a message generating unit to generate a radio resource control (RRC) connection reconfiguration message including information associated with a CC to be reconfigured in the UE; and
a transmitting unit to transmit the generated message to the UE through use of a primary cell or a secondary cell,
wherein the controller performs controlling so that the receiving unit receives a CC reconfiguration complete message including a reconfiguration result of the reconfigured CC from the UE, and controls the transmitting unit and the receiving unit to perform transmission and reception of data with the UE, based on a configuration of the reconfigured CC.

28. A user equipment (UE), comprising:
a message generating unit to generate a message including information associated with a component carrier (CC) to be reconfigured in a secondary cell;
a transmitting unit to transmit the generated message to the eNB;
a receiving unit to receive, from the eNB through a primary cell or the secondary cell, a radio resource connection (RRC) reconfiguration message including information associated with the CC to be reconfigured; and
a controller to control the message generating unit, the transmitting unit, and the receiving unit,
wherein the message generating unit generates a CC reconfiguration complete message including a reconfiguration result associated with the received reconfiguration message; and
wherein the controller performs controlling so that the transmitting unit transmits the CC reconfiguration complete message to the eNB, and controls the receiving unit and the transmitting unit to perform reception and transmission of data with the eNB based on a configuration of the reconfigured CC.
